(19) United States
(12) Patent Application Publication
(10) Pub. No.: US 2013/0021704 A1
(43) Pub. Date: Jan. 24, 2013

(54) OVER-CURRENT AND OVER-TEMPERATURE PROTECTION DEVICE

(71) Applicants: Chun Teng TSENG, Sanwan Township (TW); David Shau Chew Wang, Taipei City (TW)

(72) Inventors: Chun Teng TSENG, Sanwan Township (TW); David Shau Chew Wang, Taipei City (TW)

(73) Assignee: POLYTRONICS TECHNOLOGY CORP., Hisinchu (TW)

(21) Appl. No.: 13/186,736

(22) Filed: Jul. 20, 2011

(51) Int. Cl. H02H 5/04

(52) U.S. Cl. 361/93.8

(57) ABSTRACT

An over-current and over-temperature protection device includes a first conductive member, a second conductive member, a resistive device, at least one current input electrode and at least two current output electrodes. The first conductive member has a current input portion and a first insulative portion restricting current to only input through the current input portion, and the second conductive member has two or more current output portions and a second insulative portion restricting current to only output through the current output portions, in which the current output portions are electrically isolated by the second insulative portion. The resistive device is laminated between the first conductive member and the second conductive member. The current input electrode is electrically connected to the current input portion, and current output electrodes are electrically connected to the current output portions individually.

### CROSS-REFERENCE TO RELATED APPLICATIONS

Not applicable.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### INCORPORATION-BY-REFERENCE OF MATERIALS SUBMITTED ON A COMPACT DISC

Not applicable.

### BACKGROUND OF THE INVENTION

1. Field of the Invention

The present application relates to a passive component, and more particularly to an over-current and over-temperature protection device.

2. Description of Related Art Including Information Disclosed Under 37 CFR 1.97 and 37 CFR 1.98

Thermistors are used to protect circuits to avoid over-temperature or over-current damages. A thermistor typically includes two electrodes and a resistive material between them. This resistive material has low resistance at room temperature, and the resistance will abruptly increase to a thousand times when the temperature reaches a critical temperature or the circuit has over-current, so as to suppress over-current for circuit protection.

When the temperature decreases to room temperature or over-current no longer exists, the thermistor returns to low resistance. Then the circuit operates normally. In view of the advantage of recovery, thermistors can replace fuses to be widely used in high density circuits.

Electronic devices are being developed with downsizing trend, but passive components generally occupy the largest area in the electronic devices. If the passive components can be integrated efficiently, then the tiny electronic devices can be made in compliance with the downsizing requirement.

However, known thermistors are designed with a single function and single circuit loop. When electronic products need thermistors of different functions for protection, a lot of single function thermistors are needed to be placed in the electronic products. Not only do the thermistors increase manufacturing cost, but also they occupy large volume in the electronic products.

### BRIEF SUMMARY OF THE INVENTION

The present application provides a multi-port over-current and over-temperature protection device. In an embodiment, an electrode of the device can be separated into multiple independent areas by cutting, laser or lithography followed by etching patterning techniques, so as to separate the electrode into two or more independently electrical pieces. A surface-mount device (SMD) can be made by associating with hot press and circuit printing techniques. Accordingly, the multi-port over-current and over-temperature protection device of the present application can provide two or more loops for over-current and over-temperature protections.

In accordance with an embodiment of the present application, an over-current and over-temperature protection device includes a first conductive member, a second conductive member, a resistive device, at least one current input electrode, and at least two current output electrodes. The first conductive member has at least one current input portion and a first insulative portion restricting current to only input through the current input portion. The second conductive member has at least two current output portions and a second insulative portion restricting current to only output through the current output portions. The current output portions are electrically insulated from each other by the second insulative portion. The resistive device is laminated between the first conductive member and the second conductive member and exhibits positive temperature coefficient or negative temperature coefficient behavior. The current input electrode is electrically connected to the current input portion, and the current output electrodes are electrically connected to the current output portions individually, i.e., the current output electrodes are connected to the current output portions one-to-one. The current input electrode and the current output electrodes serve as interfaces connecting to source power. The current input electrode, the resistive device and each of the current output electrodes are connected in series.

In another embodiment of the present application, an over-current and over-temperature protection device includes a plurality of assembly devices each having the above-mentioned first conductive member, the resistive device and the second conductive member, at least one current input electrode electrically connected to the current input portion of the first conductive member, and at least two current output electrodes individually electrically connected to the at least two current output portions of the second conductive member. Insulated layers may be formed between the assembly devices. The current input electrode, the resistive devices of the assembly devices, and current output electrode are connected in parallel.

### BRIEF DESCRIPTION OF THE SEVERAL VIEWS OF THE DRAWINGS

The present application will be described according to the appended drawings in which:

FIGS. 1A through 1D show an over-current and over-temperature protection device in accordance with a first embodiment of the present application;

FIGS. 2A through 2C show an over-current and over-temperature protection device in accordance with a second embodiment of the present application;

FIGS. 3A and 3B show an over-current and over-temperature protection device in accordance with a third embodiment of the present application;

FIGS. 4A and 4B show an over-current and over-temperature protection device in accordance with a fourth embodiment of the present application; and

FIG. 5 shows an over-current and over-temperature protection device in accordance with a fifth embodiment of the present application.

### DETAILED DESCRIPTION OF THE INVENTION

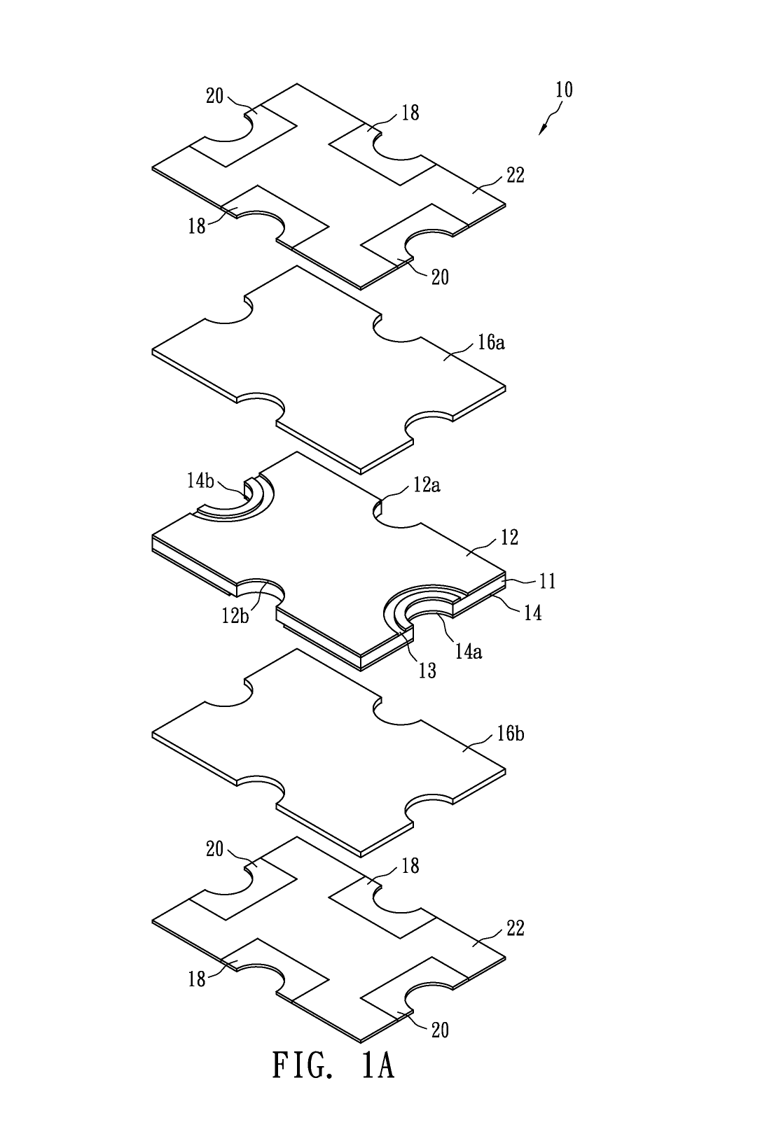

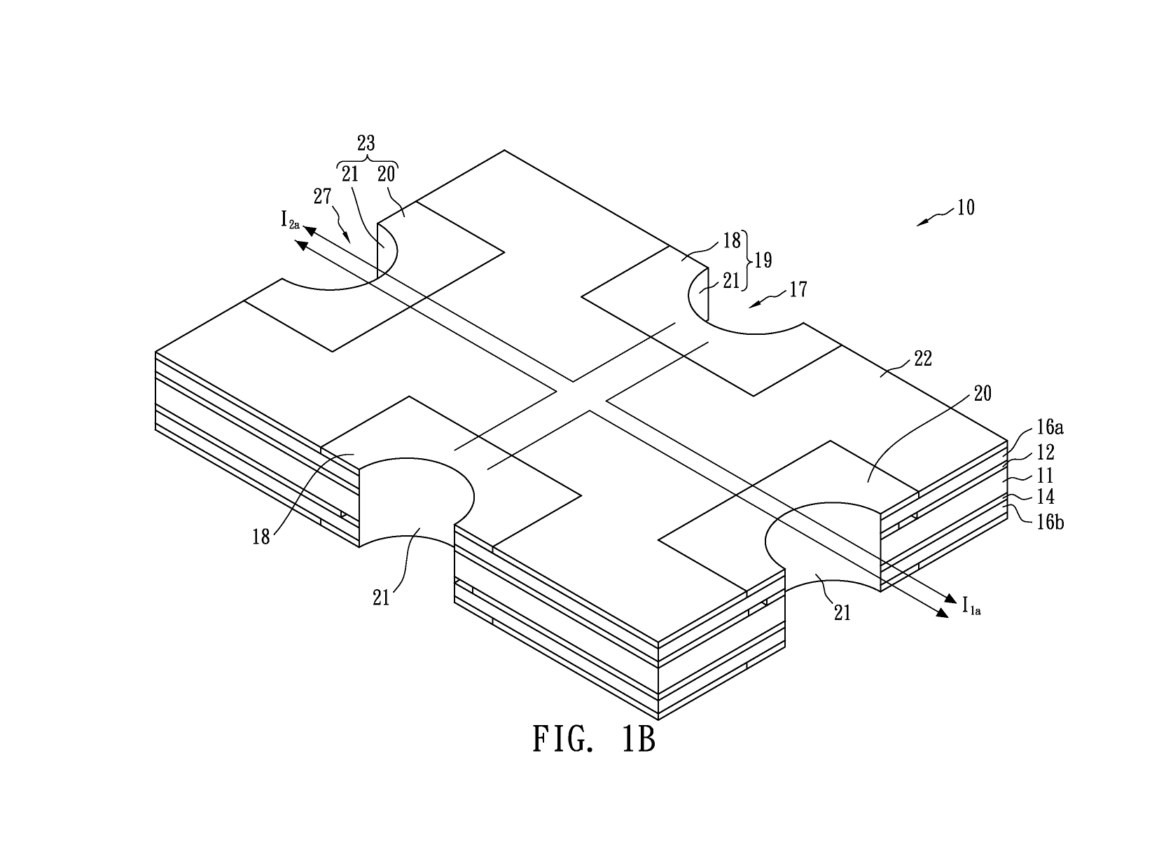

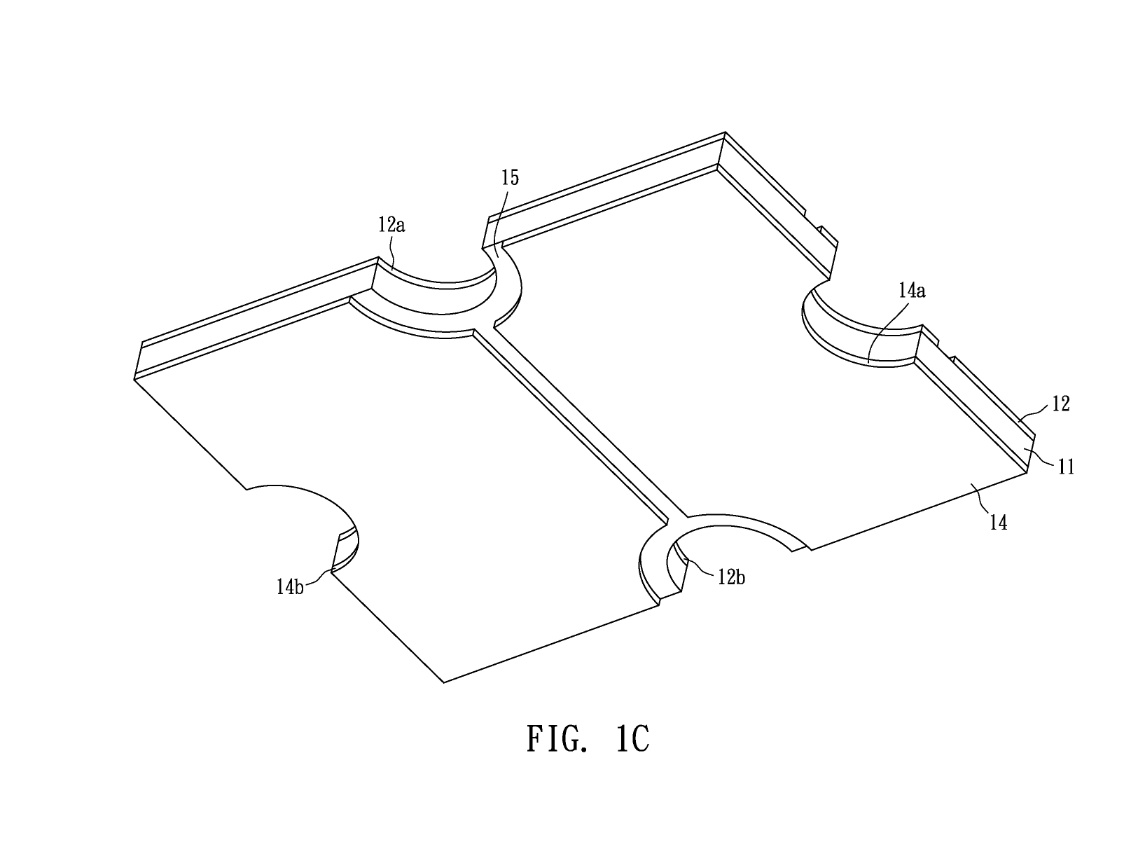

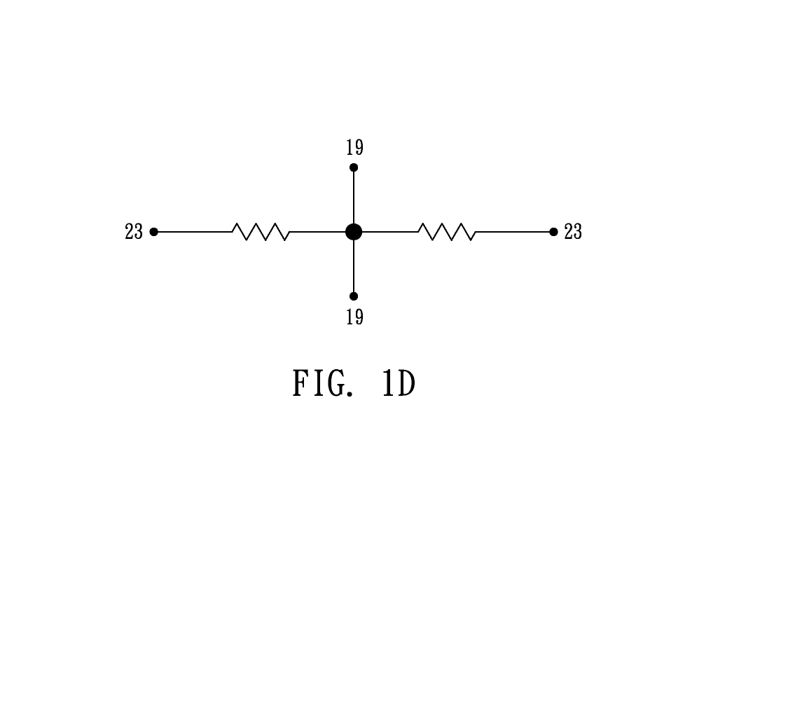

FIGS. 1A through 1C show a two-port over-current and over-temperature protection device 10 in accordance with a first embodiment of the present application. FIG. 1A shows an exploded view of the over-current and over-temperature protection device 10. FIG. 1B shows a three-dimensional view of the over-current and over-temperature protection device 10. FIG. 1C shows the bottom view of the assembly of the resistive device 11 and the upper and lower conductive members 12 and 14 of the over-current and over-temperature protection device 10. FIG. 1D shows an equivalent circuit diagram of the over-current and over-temperature protection device 10.

The over-current and over-temperature protection device 10 is a laminated structure and includes a thin resistive device 11, a first conductive member 12, a second conductive member 14, a first insulated layer 16a, a second insulated layer 16b, current input electrodes 19 and current output electrodes 23. The resistive device 11 is laminated between the first conductive member 12 and the second conductive member 14, and the first insulated layer 16a and the second insulated layer 16b are formed on the first conductive member 12 and the second conductive member 14, respectively.

The over-current and over-temperature protection device 10 is of a rectangular shape, and semi-circular conductive holes 17 and 27 are formed at four sidewalls of the device 10. The first conductive member 12 includes two current input portions 12a and 12b at two opposite holes 17, and first insulative portions 13 restricting current to only input through the current input portions 12a and 12b. The second conductive member 14 includes two current output portions 14a and 14b at two opposite holes 27, and a second insulative portion 15 restricting current to only output through the current output portions 14a and 14b. In an embodiment, the first insulative portions 13 are placed around the conductive holes 27 corresponding to the current output portions 14a and 14b. The second insulative portion 15 is placed around the conductive holes 17 corresponding to the current output portions 12a and 12b, and insulates the current output portion 14a from the current output portion 14b.

The current input electrode 19 includes a pair of electrode foils 18 disposed on the first insulated layer 16a and the second insulated layer 16b, and a conductive connecting portion 21 electrically connected to the current input portion 12a or 12b. For clearly describing the device, FIGS. 1A and 1C show the structure without the conductive connecting portion 21. The current output electrode 23 includes a pair of electrode foils 20 disposed on the first insulated layer 16a and the second insulated layer 16b, and a conductive connecting portion 21 electrically connected to the current output portion 14a or 14b. The current input electrode 19, e.g., the electrode foil 18, and the current output electrode 23, e.g., the electrode foil 20, are electrically separated by an insulated member 22.

The resistive device 11 can be a polymer material layer, a resistive material layer, a capacitive layer or an inductance layer. In an embodiment, the resistive device 11 includes polymer with dispersed conductive fillers therein, and performs positive temperature coefficient or negative temperature coefficient behavior. The polymer includes polyethylene, polypropylene, polyvinyl fluoride, the mixture or copolymer thereof. The conductive fillers can be metal fillers, carbon-containing fillers, metal oxide, metal carbide such as titanium carbide, tungsten carbide, vanadium carbide, zirconium carbide, niobium carbide, tantalum carbide, molybdenum carbide and hafnium carbide, metal boride such as titanium boride, vanadium boride, zirconium boride, niobium boride, molybdenum boride or hafnium boride, metal nitride such as zirconium nitride, or the mixture thereof.

In an embodiment, metal foils may be subjected to cutting, laser or lithography-etching process to form gaps such as the first insulative portions 13 of the first conductive member 12 and the second insulative portion 15 of the second conductive member 14. The first conductive member 12 and the second conductive member 14 can be selected from the group consisting of nickel, copper, zinc, silver, gold, the alloy or a multi-layer thereof.

After the gaps are formed, superior adhesive films such as epoxy resin composite material or polyimide composite material, e.g., the insulated layer 16a and the insulated layer 16b, combine the assembly of the resistive device 11, the first conductive member 12 and the second conductive member 14 with an upper copper foil and a lower copper foil by hot press. Then the upper and lower copper foils can be etched to form the electrode foils 18 corresponding to the current input portions 12a and 12b, and the electrode foils 20 corresponding to the current output portions 14a and 14b.

The current input electrodes 19 and the current output electrode 23 can selectively connect electrodes by electroplating on holes or sidewalls, so as to electrically connect current input portions 12a, 12b and current input electrodes 19, and to electrically connect current output portions 14a, 14b and current input electrodes 23. The insulated member 22 such as a solder mask material layer can be formed between the current input electrode 19 and the current output electrode 23 for insulation.

The conductive holes used for electrical connection are exemplified below. A conductive layer of, for example, copper, gold, silver, nickel, tin or the alloy thereof can be formed on the holes 17, 27 by electroless-plating or electroplating, thereby forming the conductive connecting portions 21 to electrically connecting the upper and lower electrodes. The conductive connecting portion 21 of the hole 17 connects the first conductive member 12 and the upper and lower electrode foils 18. The conductive connecting portion 21 of the hole 27 connects the second conductive member 14 and the upper and lower electrode foils 20. The cross-section of the holes 17 and 27 can be circular, semi-circular, quarter-circular, arc, square, diamond, rectangular, triangular or polygonal. Semi-circular holes are exemplified in this embodiment. Alternatively, the conductive holes can be formed within the device 10, or can be blind holes electrically connecting the current input portion and current input electrode, and electrically connecting the current output portion and current output electrode. Various electrical connections in the field can also be used in the present application.

In summary, the current input electrode 19 includes a pair of electrode foils 18 and the conductive connecting portion 21 (conductive film), and the pair of electrode foils 18 are formed on the first insulated layer 16a and the second insulated layer 16b. The conductive connecting portion 21 couples the pair of the electrode foils 18 with the first conductive member 12 through the current input portions 12a and 12b. The current output electrode 23 includes a pair of electrode foils 20 and the conductive connecting portion 21, and the pair of electrode foils 20 are formed on the first insulated layer 16a and the second insulated layer 16b. The conductive connecting portion 21 couples the pair of the electrode foils 20 with the second conductive member 14 through the current output portions 14a and 14b. In an embodiment, the current input electrode 19 and the current output electrode 23 are formed on the sidewall of the device 10 and are electrically connected to the first conductive member 12 and the second conductive member 14, respectively. The current input electrode 19 and the current output electrode 23 further extend to the surface of the device 10, i.e., the surfaces of the first insulated layer 16a and the second insulated layer 16b.

The first conductive member 12 is insulated from the conductive connecting portion 21 of the conductive hole 27 through the insulative portion 13, and the second conductive member 14 is insulated from the conductive connecting portion 21 of the conductive hole 17 through the insulative portion 15. The insulative portions 13 and 15 restrict currents I₁ₐ ^{and I}₂ₐ in FIG. 1B to go through the path of the current input electrodes 19, the current input portions 12a, 12b of the first conductive member 12, the resistive device 11, the current output portions 14a, 14b, and the current output electrodes 23. Each of the current input electrodes 19, the resistive device 11 and each of the current output electrodes 23 are connected in series, so as to provide a two-port over-current and over-temperature protection function.

Note that the currents I₁ₐ, I₂ₐ are exemplified only. The direction of currents could be opposite and also provide equivalent function. The over-current and over-temperature protection device also can be used in upside-down manner.

The insulated layers 16a, 16b are formed between the current input and output electrodes 19, 23 and the first and second conductive members 12, 14, and conductive connecting portions 21 are used for electrical connection therebetween. However, people having ordinary skill in the art can also perform electrical connection of electrodes in the case that the device has no insulated layers.

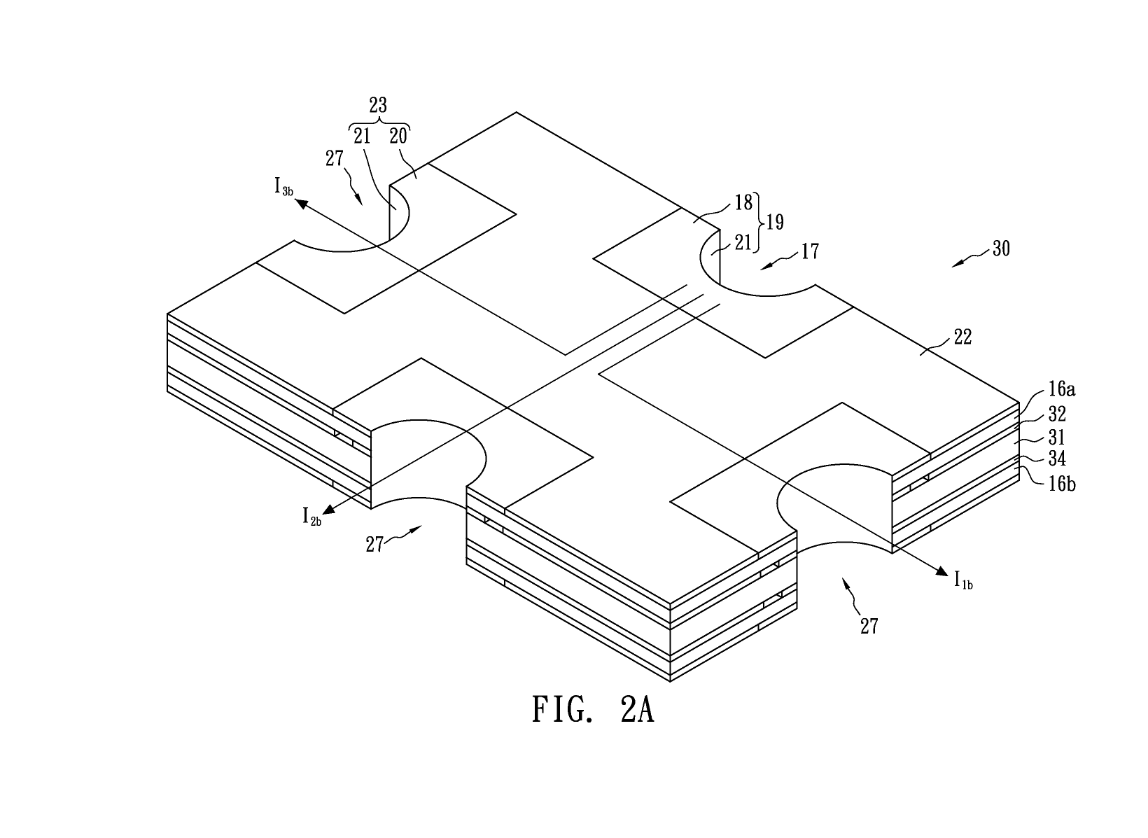

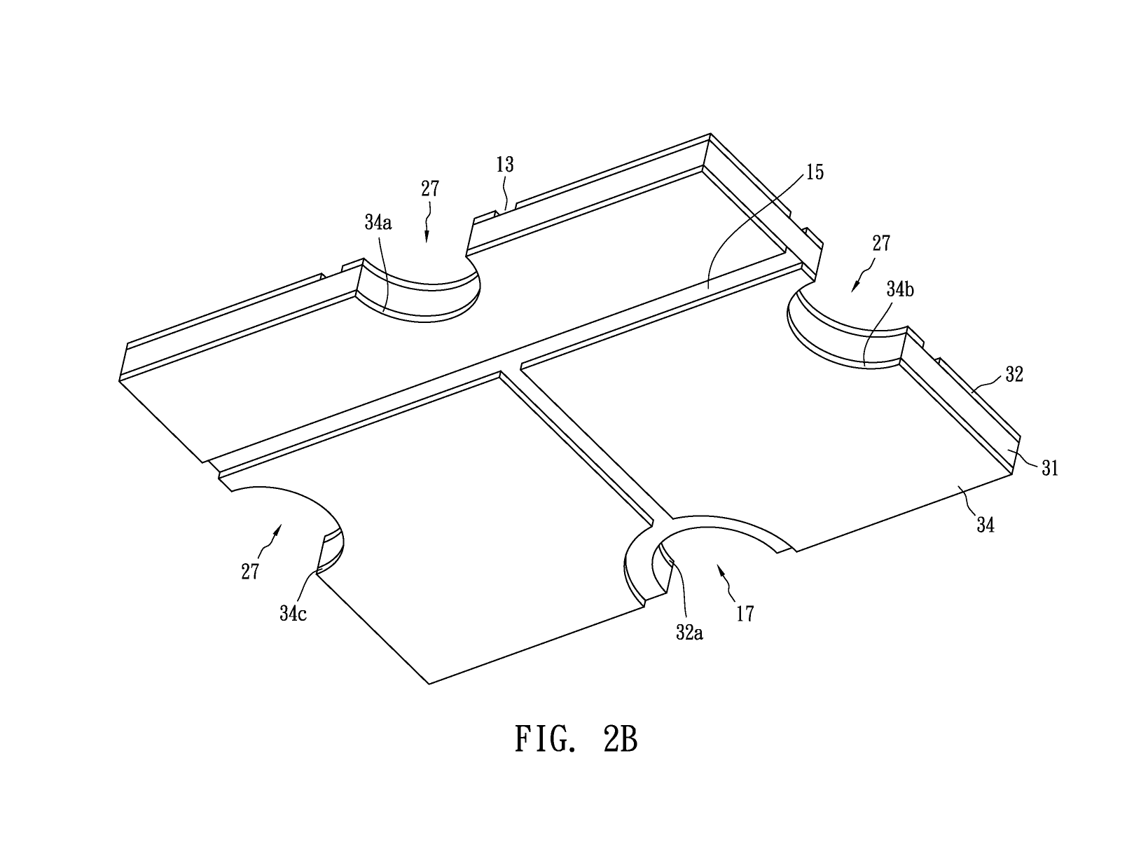

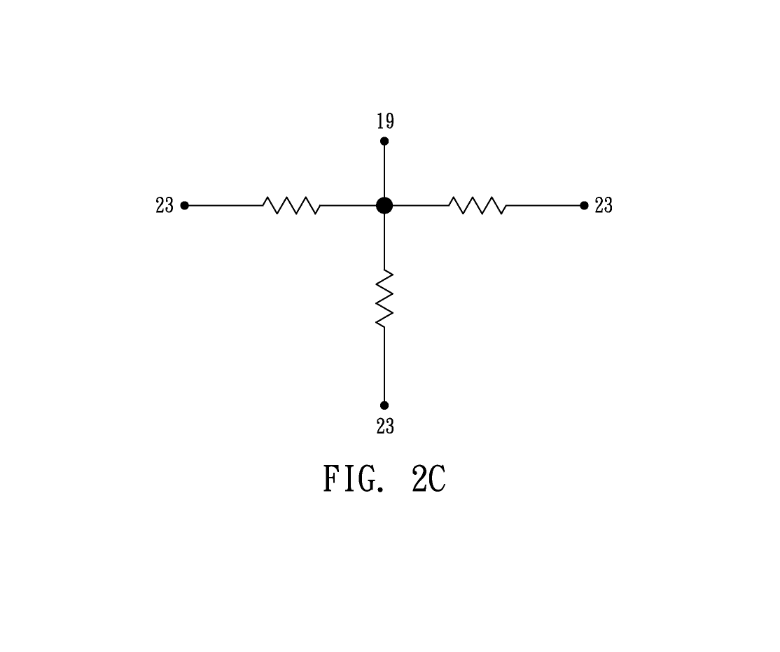

FIGS. 2A through 2C show the over-current and over-temperature protection device in accordance with a second embodiment of the present application. FIG. 2A shows a three-port over-current and over-temperature protection device 30. FIG. 2B shows the bottom view of the resistive device 31, the first conductive member 32 and the second conductive member 34 of the over-current and over-temperature protection device 30. FIG. 2C shows an equivalent circuit diagram of the three-port over-current and over-temperature protection device 30. The three-port over-current and over-temperature protection device 30 is similar to the two-port over-current and over-temperature protection device 10; nevertheless, the insulative portions 13 of the first conductive member 32 are placed around three conductive holes 27 to restrict current only to input through the current input portion 32a, and the second conductive member 34 are separated into three parts by the insulated portion 15 to restrict current to only output through the current output portions 34a, 34b and 34c.

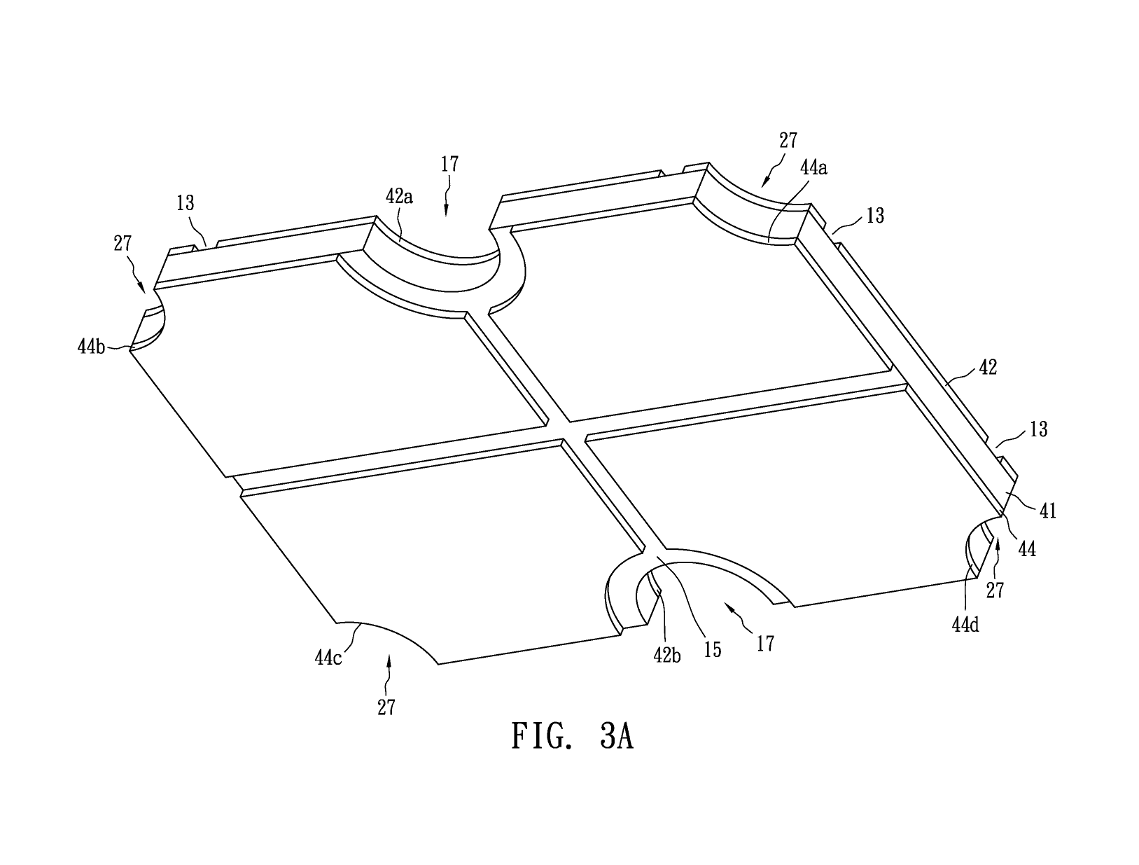

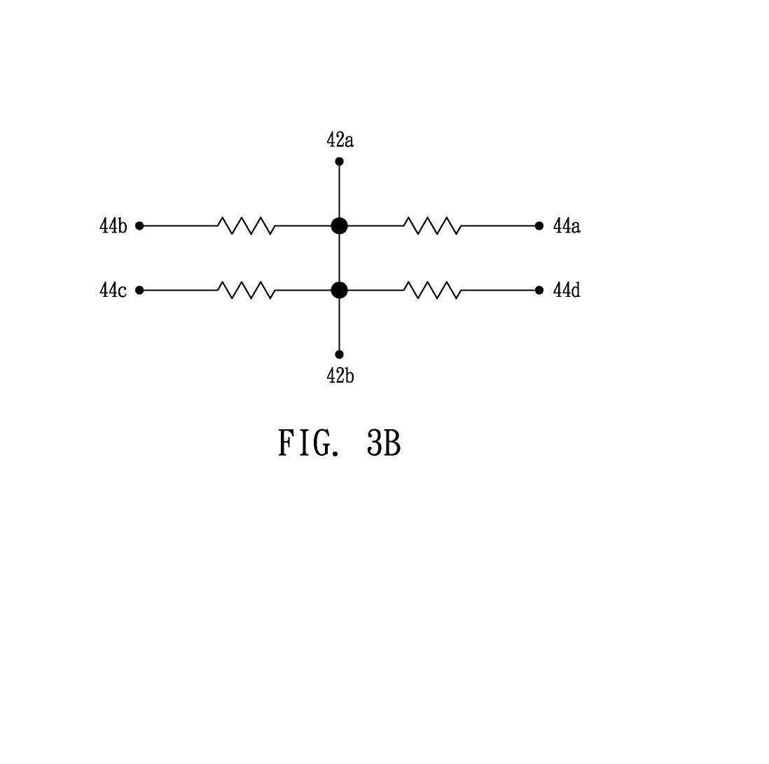

FIG. 3A shows a bottom view of the assembly of the resistive device 41, the first conductive member 42 and the second conductive member 44 of a four-port over-current and over-temperature protection device in accordance with a third embodiment of the present application. The insulative portions 13 of the first conductive member 42 are placed around four conductive holes 27 (quarter-circular hole) to restrict current to only input through the current input portions 42a and 42b. The second conductive member 44 is separated into four parts by the insulative portion 15, so as to form four current output portions 44a, 44b, 44c and 44d. Like the first and second embodiments, the resistive device 41, the first conductive member 42 and the second conductive member 44 can be associated with a current input electrode and a current output electrode to form a four-port over-current and over-temperature protection device. The detail is omitted. FIG. 3B shows an equivalent circuit diagram of the four-port over-current and over-temperature protection device of the third embodiment of the present application.

In practice, the over-current and over-temperature protection device of other shapes such as circular shape can also be made by similar process as desired, and the device with five or more ports is also producible.

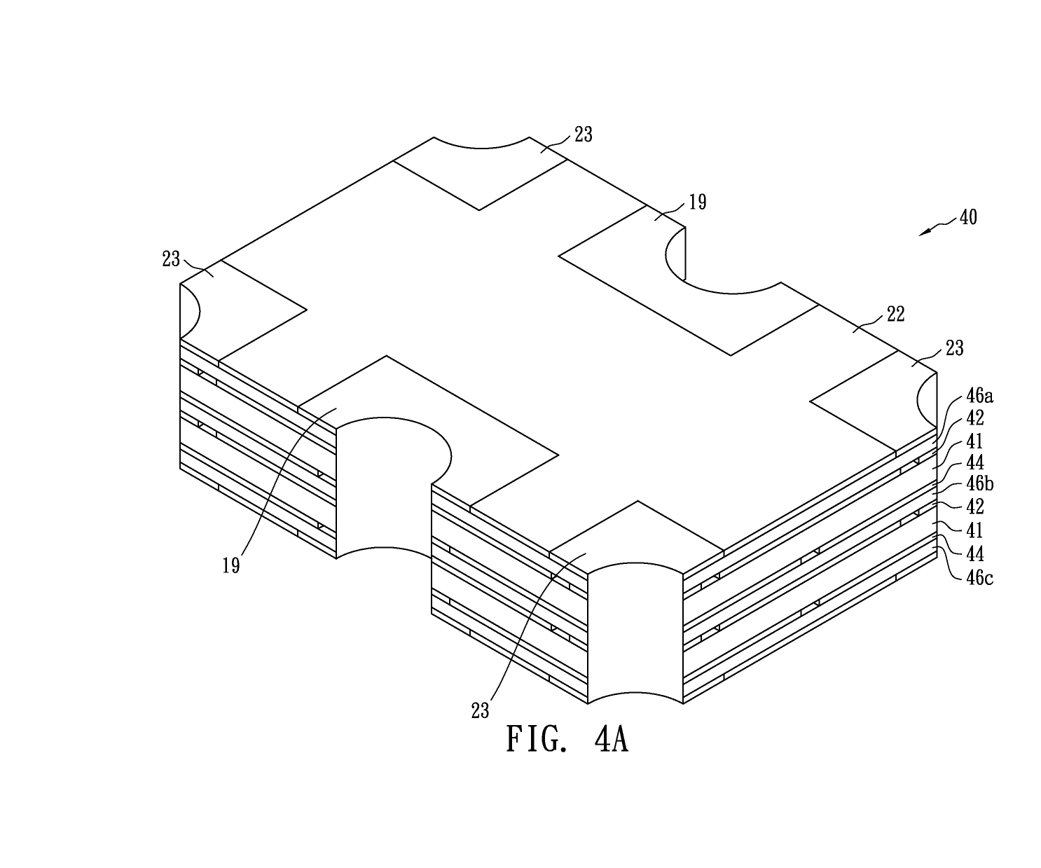

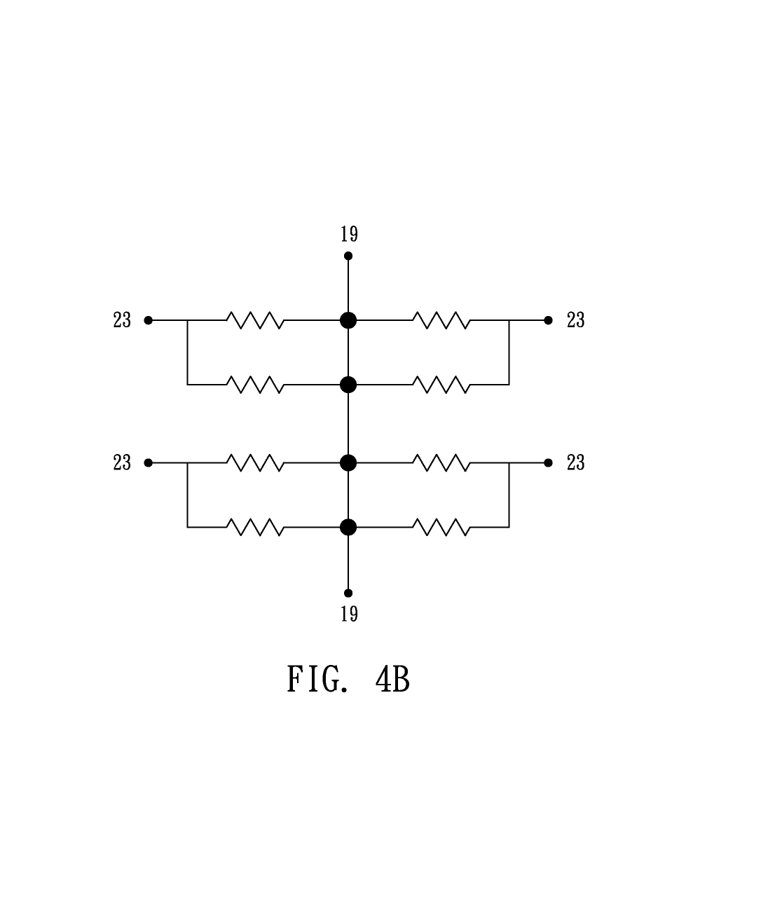

In FIG. 4A, two assembly devices each having the resistive device 41, the first conductive member 42 and the second conductive member 44 can be stacked, and then insulated layers 46a, 46b and 46c, the current input electrode 19 and the current output electrode 23 are made by a similar process. The current input electrode 19 electrically connects the current input portions of the first conductive member 42 of each assembly device, and the current output electrode 23 electrically connects the current output portions of the second conductive member 44 of each assembly device, so as to form a four-port over-current and over-temperature protection device 40 with a parallel circuit. In other words, the current input electrode 19, two of the resistive devices 41 of the assembly devices and the current output electrode 23 are connected in parallel. FIG. 4B shows an equivalent circuit diagram of the over-current and over-temperature protection device 40.

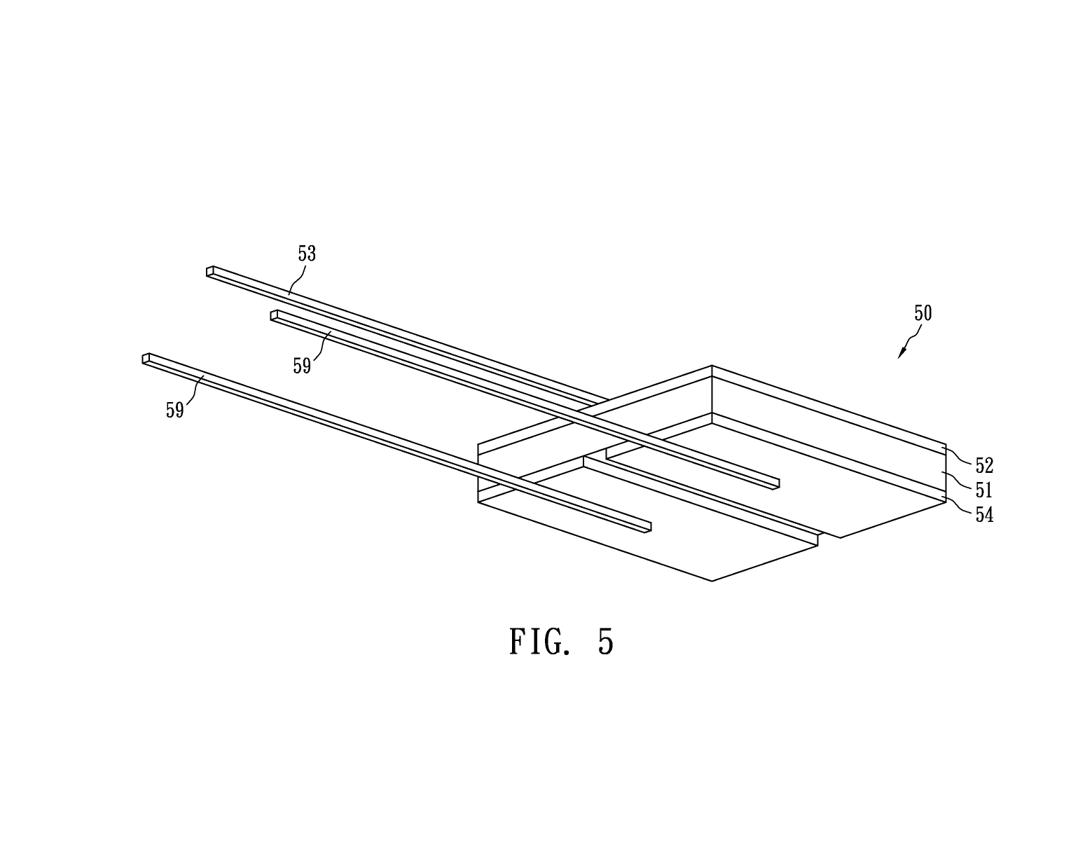

The above relates to surface-mount device (SMD) applications; however, other types using the same feature of the present application are also practical to comply with various needs. FIG. 5 shows an over-current and over-temperature protection device of radial-leaded type in accordance with the fifth embodiment of the present application. An over-current and over-temperature device 50 includes a resistive device 51, a first conductive member 52, a second conductive member 54, a current input electrode 53 and two current output electrodes 59. Likewise, the resistive device 51 is laminated between the first conductive member 52 and the second conductive member 54, and the second conductive members 54 is separated into two parts insulated from each other by a gap. The current input electrode 53 is pin-like, and it is connected to a surface of the first conductive member 52 and extends outwards. The current output electrodes 59 are pin-like also, and they are connected to a surface of the second conductive member 54 and extend outwards. Alternatively, the current input electrode and current output electrodes can be modified to comply with axial-leaded or packaging-wire type over-current and over-temperature protection devices.

Moreover, the insulative portions can be used to form electrically separated current input portions, and each current input portion corresponds to a current output portion. As a result, a single component can include multiple independent over-current and over-temperature protection devices.

According to the present application, the over-current and over-temperature protection device with two or more ports can be widely used, and consequently the number of over-current and over-temperature protection devices can be decreased. Accordingly, the volume of the over-current and over-temperature protection devices on a circuit board can be decreased, and number of the soldering spots can be reduced as well.

The above-described embodiments of the present invention are intended to be illustrative only. Numerous alternative embodiments may be devised by persons skilled in the art without departing from the scope of the following claims.

We claim:

1. An over-current and over-temperature protection device, comprising:
a first conductive member comprising at least one current input portion and a first insulative portion, wherein the first insulative portion restricts current to only input through the at least one current input portion;
a second conductive member comprising at least two current output portions and a second insulative portion, wherein the second insulative portion restricts current to only output through the at least two current output portions, and the current output portions are insulated from each other by the second insulative portion;
a resistive device exhibiting positive temperature coefficient or negative temperature coefficient behavior and being laminated between the first conductive member and the second conductive member;
at least one current input electrode electrically connected to the at least one current input portion; and
at least two current output electrodes individually electrically connected to the at least two current output portions.

2. The over-current and over-temperature protection device of claim 1, further comprising:
a first insulated layer disposed on a surface of the first conductive member; and
a second insulated layer disposed on a surface of the second conductive member;
wherein the current input electrode is formed on the first insulated layer and the second insulated layer, and the current output electrodes are formed on the first insulated layer and the second insulated layer.

3. The over-current and over-temperature protection device of claim 2, wherein the current input electrode comprises a pair of first electrode foils and a first conductive connecting portion, the pair of first electrode foils are disposed on the first insulated layer and the second insulated layer, the first conductive connecting portion connects the pair of first electrode foils and the first conductive member through the current input portion, the current output electrode comprises a pair of second electrode foils and a second conductive connecting portion, the pair of second electrode foils are disposed on the first insulated layer and the second insulated layer, the second conductive connecting portion connects the pair of second electrode foils and the second conductive member through the current output portion.

4. The over-current and over-temperature protection device of claim 3, wherein the first conductive connecting portion and the second conductive connecting portion are formed on holes on sidewalls of the over-current and over-temperature protection device.

5. The over-current and over-temperature protection device of claim 3, wherein the first conductive connecting portion and the second conductive connecting portion comprise copper, gold, silver, nickel, tin or the alloy thereof formed by electroless-plating or electroplating.

6. The over-current and over-temperature protection device of claim 4, wherein the first insulative portion is placed around the holes with the second conductive connecting portion, and the second insulative portion is placed around the holes with the first conductive connecting portion.

7. The over-current and over-temperature protection device of claim 2, wherein the first insulative portion and the second insulative portion are gaps formed by cutting, laser or lithography-etching process.

8. The over-current and over-temperature protection device of claim 1, wherein the current input electrode, the resistive device and each of the current output electrodes are connected in series.

9. The over-current and over-temperature protection device of claim 1, wherein the resistive device comprises polyethylene, polypropylene, polyvinyl fluoride, the mixture thereof or the copolymer thereof.

10. The over-current and over-temperature protection device of claim 1, wherein the resistive device comprises metal fillers, carbon-containing fillers, metal oxide, metal carbide, metal boride, metal nitride or the mixture thereof.

11. The over-current and over-temperature protection device of claim 2, wherein the first insulated layer and the second insulated layer comprise epoxy resin composite material or polyimide composite material.

12. The over-current and over-temperature protection device of claim 1, further comprising an insulated member configured to electrically insulate the current input electrode from the current output electrodes.

13. The over-current and over-temperature protection device of claim 12, wherein the insulated member comprises solder mask material.

14. The over-current and over-temperature protection device of claim 1, wherein the over-current and over-temperature protection device is of surface-mount device.

15. The over-current and over-temperature protection device of claim 1, wherein the current input electrode and the current output electrodes are radial-leaded pin-like electrodes, the current input electrode is connected to a surface of the first conductive member and extends outward, and the current output electrodes are connected to a surface of the second conductive member and extend outward.

16. An over-current and over-temperature protection device, comprising:
a plurality of assembly devices each having a first conductive member, a resistive device and a second conductive member, the first conductive member comprising at least one current input portion and a first insulative portion which restricts current to only input through the at least one current input portion; the second conductive member comprising at least two current output portions and a second insulative portion which restricts current to only output through the at least two current output portions, and the current output portions being insulated from each other by the second insulative portion; the resistive device exhibiting positive temperature coefficient or negative temperature coefficient behavior and being laminated between the first conductive member and the second conductive member;
at least one current input electrode electrically connected to the current input portion of the first conductive member of each one of the assembly devices; and
at least two current output electrodes individually electrically connected to the at least two current output portions of the second conductive member of each one of the assembly devices;
wherein at least one first insulated layer is disposed between the assembly devices.

17. The over-current and over-temperature protection device of claim 16, wherein second insulated layers are formed between the assembly devices and the current input electrode as well as the current output electrodes.

18. The over-current and over-temperature protection device of claim 16, wherein the current input electrode, the resistive devices of the assembly devices and the current output electrode are connected in parallel.
